(19) United States
(12) Patent Application Publication
(10) Pub. No.: US 2026/0302790 A1
(43) Pub. Date: Oct. 1, 2026

(54) WIDE AREA SITE POWER AND NESTED ENERGY TRANSMISSION (WASP NET)

(71) Applicant: Joule Case Inc., Seattle, WA (US)

(72) Inventors: Alexander Livingston, Seattle, WA (US); David Mark Demuro, Seattle, WA (US)

(73) Assignee: Joule Case Inc., Seattle, WA (US)

(21) Appl. No.: 19/489,436

(22) PCT Filed: May 31, 2024
(86) PCT No.: PCT/US2024/032046

§ 371 Date: Dec. 2, 2025

Related U.S. Application Data
(60) Provisional application No. 63/470,541, filed on Jun. 2, 2023.

(51) Int. Cl. H02J 3/36; H02J 3/32; H02J 3/46; H02J 101/24; H02J 101/30; H02J 105/10

(52) U.S. Cl. CPC H02J 3/36; H02J 3/32; H02J 3/46; H02J 2101/24; H02J 2101/30; H02J 2105/10

(57) ABSTRACT

An example of a Wide Area Site Power and Nested Energy Transmission (WASP NET) system distributes electrical power over a defined physical area using high-AC voltage direct current (HVDC) transmission. The system comprises a major power-generation node connected to an HVDC transmission grid, and a plurality of secondary nodes, including power generation, conversion, and storage modules. The secondary nodes can operate independently or share power when the major node is offline, ensuring a robust and resilient power supply. The HVDC transmission reduces cabling requirements, minimizes electromagnetic interference, and increases power transmission capacity compared to traditional AC systems. A control system manages power distribution and sharing among the nodes, while a centralized battery swapping system optimizes performance and reduces maintenance. The modular and nested architecture enables seamless integration of various power generation and distribution nodes, providing flexibility and scalability for temporary and semi-permanent power solutions in construction, events, and remote installations.

### TECHNICAL FIELD

This disclosure relates generally to electrical-power-distribution systems, and more particularly to the generation, production, transmission, capture, consumption, intended disruption, or addition of such distribution systems within a physical area via electrically conductive material.

### BACKGROUND

Temporary power-distribution services have historically utilized a single point of production with multiple points of electrical transformation and consumption taking place downstream from the center of power production. Such systems today provide temporary or semipermanent power to construction sites, micro/nano grids, entertainment venues such as music festivals, carnivals, sporting events, etc. where the availability of a typical grid is limited or nonexistent.

Typical local-area or wide-area physical sites such as music festivals, construction sites, and even grid-forming military or government installations or facilities use medium-voltage (200-500 Volts) alternating current (AC) commonly in three phases, which uses three primary current-carrying cables or lines plus a common neural and a grounding or earth line, or three current-carrying lines, a common-neutral line, and a ground spike.

Such a medium-voltage AC system allows voltage conversion (e.g., for powering loads) in most instances to take place at one or more voltage transformers. Such transformers are typically conductive wires wound in a fashion such that using the natural properties of an induced magnetic field, such a transformer can change the alternating current (AC) voltage to a specified winding on the opposing side.

Alternating current (AC) has been preferred to send power over longer distances; for purposes of this application, ‘longer distance’ covers distances from ~0 meters up to a few thousand collective meters in the system. An AC signal switches direction of electron flow at a defined rate or frequency (in units of Hertz (Hz)) using international or application-specific standards. For example, household voltage (110-240 vac) switches direction at 50 or 60 Hertz. But aircraft, sensitive, and higher-power electronics often can receive 400 Hz, and, in many instances, motors can be controlled by pulsing the frequency from 0 -550 Hz with a variable frequency drive.

Dating back to Thomas Edison (direct current (DC)) and Nikola Tesla (alternating current (AC)), there has been a debate about which form of electricity was safer, more reliable, more efficient, and more economical for a power grid. State-of-the-art technology from the time made it such that Tesla's alternating current (AC) was selected to demonstrate the first large-area electric grid and long-distance transmission of power at the World's Fair in 1893.

Since that time, modern technologies have changed many of the key factors in the choices for wide-area power distribution from medium voltage AC (120-500 vac) to high-voltage DC, which, for purposes of example, is in the range of approximately 500-2000 volts DC. Mass adoption of solar panels and large-scale solar production has led to significant improvements in direct-current technology, reducing the cost, weight, size, and efficiency of switched direct-current voltage. In addition, modern DC-DC converters are able to transform one DC voltage to another at high efficiency with low cost and small size, whereas typical 60 Hz transformers are very large, heavy, and expensive.

There are additional natural benefits in utilizing high-voltage DC to transmit power in wide areas as described. Direct Current does not create the same magnetic fields as AC, which magnetic fields can interfere in sensitive electronics through ElectroMagnetic Interference (EMI). Such interference can wreak havoc in video, audio, and even control electronics in pacemakers. While the industry is careful to reduce EMI generated in devices, naturally formed current fields can be accidentally created in a wide area for power distribution, especially with the mass utilization of alternating-current transformers, which also commonly produce an audible sound during operation. The simplistic operation of these large, typically copper-winding, transformers has been negated due to the cost of copper, and the weight of these transformers, which are now outdated with the mass adoption of switching electronics.

Furthermore, paramount to any electrical-distribution system is safety, especially when the components are expected to operate around people and, when the components are temporary (e.g., in a power system for an event such as a concert), they need to withstand human error of mishandling or possibility of damage to the infrastructure, which damage may compromise the current-handling portion of the system (wire/cables).

In addition, alternating-current flow can create small electromagnetic fields, which can induce system voltages as these fields are formed and dissipate. This phenomenon is called the “skin effect” and makes the choice of conductors for alternating current complex, and there are a variety of different strategies to combat the increased impedance potentially created by the skin effect to insure a low resistance over the cross section of the conductor. In contrast, Direct Current does not create such a skin effect.

Moreover, while any stray electricity and, specifically current, can be harmful to the human body, alternating current can arrest muscles and interrupt the heart's rhythm.

While Direct Current can be damaging, especially at high voltages, there is only one live current-carrying wire in a DC Power distribution system, which can lead to simplified strategies to protect the single live wire or conductor.

Matched frequencies are also an issue for alternating current when trying to add or take away power-producing or -conducting portions of a given array. Alternating current, whether single or multi-phase, requires phase matching for proper grid forming; if the sinusoidal wave form is not matching the peaks and frequency of the AC signal on the grid, proper power flow may not be achieved.

Finally, a review of the conductor and losses over a given distance for AC or DC results in a reduction of expensive (high-stranded copper cable) from four or five wires (for AC) to potentially only two wires (for DC). Take, for example, the total power that three-phase 480 v Alternating Current can move over 4 wires (3 Lines and a Ground). For this assumption, the conductor is rated for 100 Amps and the power is rated at 480 v√3=480 v(1.7) for the three line conductors times the maximum current for the conductor (100) [480×1.7×100]=81,600 Watts (W) or Volt Amps (VA) assuming no power-factor correction. The state-of-the art high-voltage systems that enable this new technology can operate in ranges of 500-2000 volts DC. Assume 1200 volts DC for this example, which results in 120,000 W with the same conductor, however alternating current in this example uses four wires and our direct-current system uses only two wires. If we were to directly compare the same voltage 480 and use the same number and rating of conductors we would see the following: [480vdc×2(wires)×100=96,000 kW] however we aren't required to use the same voltage and in fact we can assume high-power systems can utilize 1500 volts of Direct Current through this transmission system and so we can see power delivered with the same transmission conductors of: [1500×2×100 =300,000 kW] which is over 3× the same power of a comparable AC system used in these applications.

### SUMMARY

A goal of the present invention is to provide a way to improve power distribution over a physical site such as construction, festival, or other temporary site in need of power where grid may be limited or not present is described. The aim is to provide a safe, efficient system to distribute power over a defined physical area. By utilizing high-voltage DC a more robust temporary or semipermanent electrical grid can be created. The creation of such a grid using high-voltage DC transmission eliminates the complexities of AC phase matching and allows multiple nodes to be connected or disconnected and new grid distribution of nested systems based on high-voltage transmission can be realized.

The system utilizes high-voltage DC to reduce the number of power-distribution cables, reduce external interference, and eliminate stray electromagnetic fields, while matching similar levels of AC transmission total power, which commonly use three phases, a neutral, and a ground (5 wires).

In the present application, we describe a system and methods of deploying a single-point or multi-point node or array having the abilities to further nest appliances and devices within any point or node within that array to transmit power. The system and methods take advantage of many new Direct Current technologies creating a new way to transmit power over a physical area. Some of the advantages of this new method and system provide a reduction in the number and amount of electrical conductors needed compared to four conductors for Alternating Current technology or using similar numbers of conductors can dramatically increase the total amount of power the conductors can carry. A new method and system of nested devices operating within a physical area taking advantage of new Direct Current technologies provides a robust and resilient temporary power array which can operate independently, as a collective or in reconfigurable nodes and arrays across a system.

### BRIEF DESCRIPTION OF THE DRAWINGS

FIG. 1 is a block diagram illustrating an exemplary Wide Area Site Power and Nested Energy Transmission (WASP NET) system, including a major power-generation/storage node, an HVDC transmission grid, and various secondary nodes.

FIG. 2 is a flowchart depicting an exemplary method of operating the WASP NET system, including power generation, distribution, conversion, independent operation, and power sharing among nodes.

FIG. 3 is a drawing of a DC-based site map, illustrating the main components of an exemplary WASP NET system, such as Applicant's ‘Atlas’ power sources, AC and DC conversion modules, and a hybrid node with various power generation and storage modules.

FIG. 4 is a drawing of a DC-based site map with the HVDC transmission grid interrupted, demonstrating how nested node-based modules continue to operate without the presence of the HV grid, according to an example.

FIG. 5 is a drawing of a DC-based site map with battery power depleted across any given or all nodes, showing how available power generation modules (solar, hydrogen, or combustion) can be called upon to support loads or recharge battery storage, according to an example.

FIG. 6 is another drawing of a DC-based site map with battery power depleted across nodes, similar to FIG. 5, illustrating the system's response in such a scenario according to an example.

FIGS. 7A and 7B illustrate how the Atlas power source can be added to reform the HVDC grid and recharge the system in 1-2 hours when battery power is depleted, according to an example.

FIG. 8 is a drawing of a DC-based site map operating independently without the HVDC transmission grid, demonstrating the standalone operation capabilities of the WASP NET system, according to an example.

FIG. 9 is a diagram of a WASP NET system that may be further enhanced by having multiple Atlas units connected to the DC grid at the same time, according to an example.

FIG. 10 is a diagram of a WASP NET system that may be further enhanced with the inclusion of a grid connected node, according to an example.

### DETAILED DESCRIPTION OF ILLUSTRATIVE EMBODIMENTS

### Overview

The Wide Area Site Power and Nested Energy Transmission (WASP NET) system described herein provides an innovative solution for distributing electrical power over a defined physical area using high-voltage direct current (HVDC) transmission. By leveraging recent advancements in DC technologies, the WASP NET system enables the creation of robust, temporary or semi-permanent electrical grids that offer numerous advantages over traditional AC power distribution systems.

Key features and benefits of the WASP NET system include:
Reduced cabling requirements due to HVDC transmission, leading to lower installation and maintenance costs.
Minimized electromagnetic interference and elimination of stray EM fields.
Increased power transmission capacity and efficiency over long distances.
Ability to operate independently, collectively, or in reconfigurable nodes and arrays.
Incorporation of renewable energy sources like solar to reduce fossil fuel reliance.
Resilient operation with local energy storage at nodes to mitigate grid disruptions.
Versatile hybrid nodes providing both AC and DC power to diverse loads.
Modular and scalable design allowing easy expansion and customization.
Centralized battery swapping to optimize performance and simplify maintenance.

The WASP NET architecture, with its major power-generation node, HVDC transmission backbone, and various secondary nodes, provides a flexible and efficient framework for deploying a microgrid tailored to the specific power needs of a wide variety of applications and environments. The system's innovative features combine to deliver a superior power distribution solution.

### System Architecture

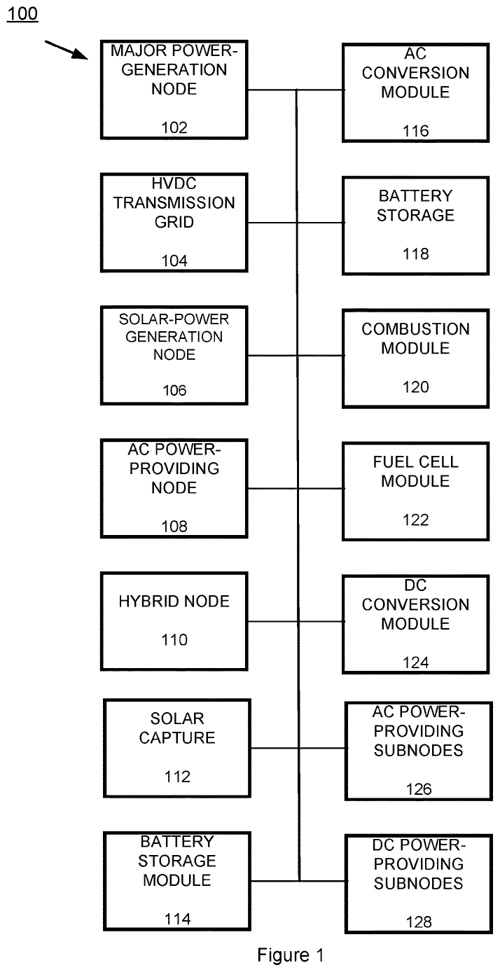

The WASP NET system 100, as depicted in FIG. 1, comprises a major power-generation node 102 that serves as the primary energy source for the entire system.

This node may include high-capacity energy sources such as Atlas power sources, which can provide 170 kWh or 350 kWh of energy storage. The significant energy storage capacity of the major power-generation node 102 ensures a stable and reliable power supply for the connected secondary nodes. By centralizing the main power generation and storage at this node, the system reduces the need for large energy storage units at each secondary node, leading to a more efficient and cost-effective solution.

The Atlas power system is Applicant's high-capacity battery module designed for demanding grid-scale applications, including but not limited to massive EV fleet charging, supporting Applicant's larger Zeus energy storage system, and enabling a fast transition to renewable energy sources. The Atlas is a versatile, high-capacity, DC-coupled battery system optimized for fast charging of large-scale EV fleets and easy integration with renewable energy sources and other energy storage products. Its modular design allows it to scale to very high power levels to meet the most demanding grid-scale energy applications. Key features and capabilities of the Atlas power system include:
Future-proof energy source and EV charging system with built-in DC/DC bidirectional converters.
Can handle any renewable energy source or power requirement.
Onboard DC converters allow a single Atlas unit to provide Level 3 DC Fast Charging for multiple EVs with minimal on-site infrastructure.
Multiple Atlas units can be combined to provide megawatt-scale DC Fast. Charging for heavy-duty vehicles like metro fleet vehicles and long-haul trucks.
Delivers high power levels that the current electrical grid cannot supply, enabling electrification of heavy transport.
Atlas battery modules can be swapped to provide endless energy to their larger Zeus energy storage and inverter system.

Referring to FIG. 1, the major power-generation node 102 is connected to a high-voltage DC (HVDC) transmission grid 104, which acts as the backbone for power distribution throughout the system. The HVDC transmission grid 104 offers several advantages over traditional AC transmission systems. By using high-voltage DC, the system can reduce the number of power-distribution cables required, as HVDC transmission typically requires fewer conductors compared to AC systems. This reduction in cabling leads to lower installation and maintenance costs, as well as reduced space requirements for cable routing. Additionally, HVDC transmission minimizes external interference and eliminates stray electromagnetic fields, which can be problematic in sensitive electronic environments. The use of HVDC also enables the system to transmit power more efficiently over longer distances, as it experiences lower power losses compared to AC transmission.

The WASP NET system 100 includes various secondary nodes that serve specific functions within the power distribution network. The minor solar-power generation node 106 is equipped with a solar capture module 112 and a battery storage module 114.

This node generates renewable energy using solar panels and stores the generated energy in the battery storage module for later use. By incorporating solar power generation, the WASP NET system can reduce its reliance on fossil fuels and contribute to a more sustainable power solution. The battery storage module 114 at the solar-power generation node 106 allows for the storage of excess solar energy during peak sunlight hours, which can then be distributed to other nodes when needed, enhancing the overall efficiency and reliability of the system.

The AC power-providing node 108 is responsible for converting the HVDC power from the transmission grid 104 to AC power, which is suitable for use by connected loads that require alternating current. This node includes an AC conversion module 116 that performs the DC-to-AC conversion, ensuring a stable and efficient power supply to AC loads. The battery storage module 118 at the AC power-providing node 108 serves as a local energy storage unit, providing uninterrupted power supply to the connected loads in case of disruptions in the HVDC transmission grid. This local energy storage capability enhances the overall resilience of the system, allowing the AC power-providing node to operate independently for a certain period, even if the main power supply from the transmission grid is interrupted.

The hybrid node 110 demonstrates the versatility and scalability of the WASP NET system, as it combines both power generation and power distribution capabilities within a single node. This node may include a combustion module 120 or a fuel cell module 122 for generating power. The combustion module 120 can utilize various fuel sources, such as natural gas or propane, to generate electricity, while the fuel cell module 122 can convert hydrogen fuel into electrical energy through an electrochemical process. The generated power from these modules is then converted to HVDC by a DC conversion module 124 for efficient distribution on the transmission grid 104. The integration of multiple power generation options within the hybrid node 110 provides flexibility in terms of energy sources and allows for a more reliable and adaptable power supply.

Moreover, the hybrid node 110 includes AC power-providing subnodes 126 and DC power-providing subnodes 128, enabling it to supply both AC and DC power to connected loads. This feature is particularly useful in scenarios where loads require distinct types of power, such as in industrial or commercial settings. The AC power-providing subnodes 126 are equipped with AC conversion modules to convert the HVDC power from the transmission grid to AC power, while the DC power-providing subnodes 128 can directly supply DC power to compatible loads. The ability to provide both AC and DC power within a single node streamlines the power distribution process and reduces the need for additional conversion equipment at the load end.

The modular and scalable design of the WASP NET system allows for easy expansion and customization based on the specific power requirements of the application.

Additional secondary nodes can be added to the system as needed, and the functions of each node can be tailored to meet the demands of the connected loads. This flexibility enables the system to adapt to changing power requirements and ensures that the power distribution network can grow and evolve along with the needs of the site.

### Operation

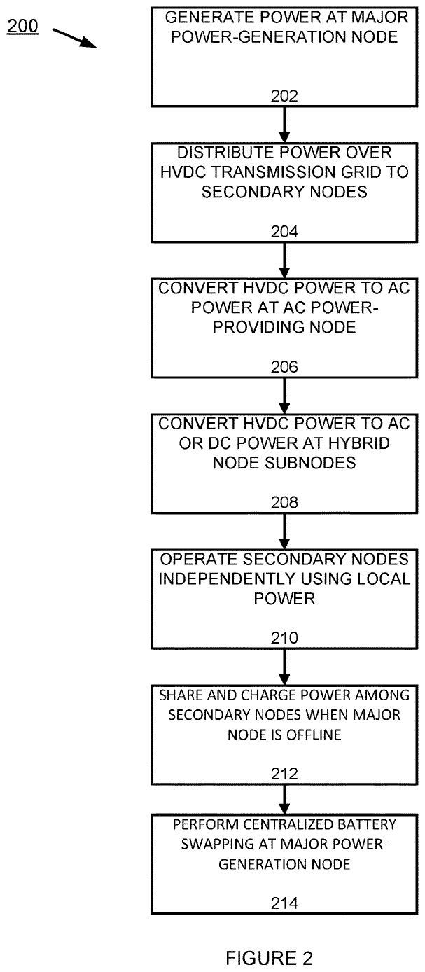

The operation of the WASP NET system, as illustrated in the flowchart of FIG. 2, begins with the generation of power at the major power-generation node (step 202). The high-capacity power sources, such as Atlas power sources, produce the required electrical energy, which is then conditioned and prepared for transmission. The use of these high-capacity power sources ensures a stable and reliable power supply to the entire system, reducing the need for frequent maintenance or replacements.

Once the power is generated, it is distributed over the HVDC transmission grid to the various secondary nodes (step 204). The HVDC transmission grid serves as the main power distribution channel, efficiently transferring electrical energy from the major power-generation node to the secondary nodes. The use of high-voltage DC transmission minimizes power losses over long distances and allows for a more efficient power distribution compared to traditional AC systems. The HVDC transmission grid also enables the system to cover a wide area, making it suitable for applications such as construction sites, festivals, or remote locations where access to the main power grid may be limited or unavailable.

At each secondary node, the received HVDC power is converted as needed to meet the requirements of the connected loads. For example, at the AC power-providing node, the HVDC power is converted to AC power by the AC conversion module (step 206). This conversion process ensures that the connected AC loads receive the appropriate form of power for their operation. The AC conversion module is designed to provide a stable and efficient power supply, maintaining the required voltage and frequency levels for the AC loads. Similarly, at the hybrid node, the HVDC power can be converted to either AC or DC power by the respective subnodes (step 208). This flexibility in power conversion allows the hybrid node to accommodate a wide range of loads with different power requirements.

In the event of power disruptions on the main HVDC transmission grid, the WASP NET system is designed to maintain a continuous power supply to critical loads. The secondary nodes can operate independently using their local power generation and storage capabilities (step 210). For instance, the minor solar-power generation node can continue to generate and store energy using its solar capture module and battery storage module. This local power generation capability ensures that the node can sustain its operation even when the main power supply from the transmission grid is interrupted. Similarly, the AC power-providing node can draw from its battery storage to maintain a stable power supply to the connected loads during grid disruptions. The independent operation of the secondary nodes enhances the overall resilience and reliability of the system, minimizing the impact of power outages on critical applications.

The WASP NET system also enables power sharing and charging among the secondary nodes, even when the major power-generation node is offline (step 212). This feature allows the nodes to exchange power based on their individual generation and storage capacities. For example, if one node has excess power generation, it can transfer the surplus energy to other nodes that may be running low on power. This power-sharing capability optimizes the utilization of available energy resources and ensures that the system can maintain a stable power supply to all connected loads. Additionally, the nodes can charge their battery storage modules using the shared power, further enhancing the system's resilience and readiness for future power disruptions.

To optimize system performance and reduce maintenance requirements, the WASP NET system incorporates a centralized battery swapping mechanism at the major power-generation node (step 214). This feature allows for the periodic replacement of the main power source batteries, ensuring that the system always operates at peak efficiency. By centralizing the battery swapping process, the WASP NET system eliminates the need for individual battery replacements at each secondary node, reducing the overall maintenance complexity and costs. The swapped batteries from the major power-generation node can then be used to charge the batteries in the secondary nodes, effectively distributing the stored energy throughout the system.

The operation of the WASP NET system, as described in the flowchart of FIG. 2, showcases its ability to provide a reliable, efficient, and flexible power distribution solution for a wide range of applications. The combination of high-capacity power generation, HVDC transmission, and modular secondary nodes allows the system to adapt to various power requirements and operating conditions. The independent operation capability of the secondary nodes, along with the power-sharing and centralized battery swapping features, enhances the system's resilience and ensures a continuous power supply even in challenging environments.

By leveraging the advantages of HVDC transmission, such as reduced cabling requirements, minimized electromagnetic interference, and increased power transmission capacity, the WASP NET system offers a superior alternative to traditional AC power distribution systems. The modular and scalable architecture of the system enables easy expansion and customization, making it suitable for a wide range of applications, from construction sites and festivals to remote locations and emergency power supply scenarios. With its focus on efficiency, reliability, and flexibility, the WASP NET system represents a significant advancement in temporary and semi-permanent power distribution solutions.

### Example Implementation

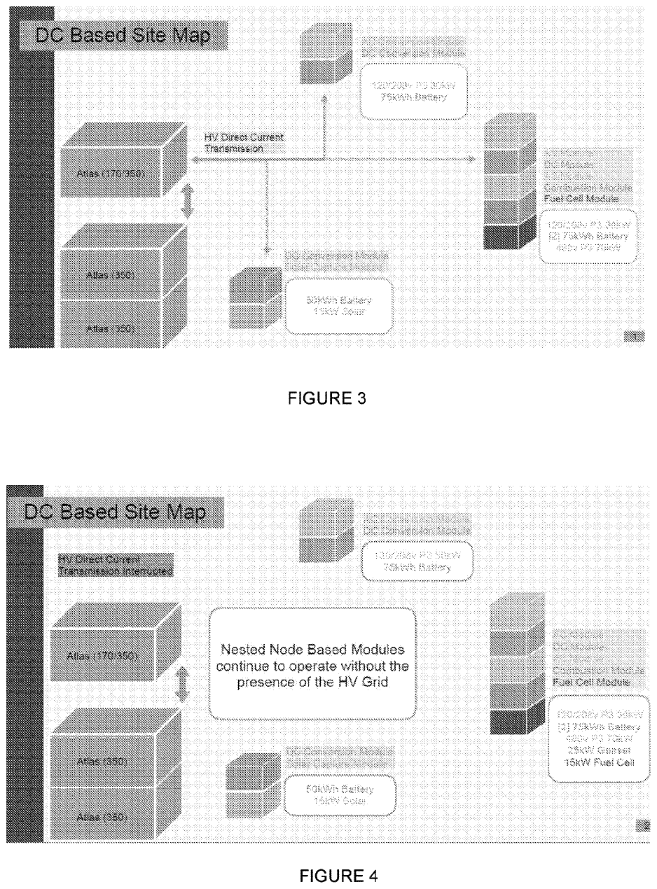

We will now provide an overview of a specific exemplary implementation of the inventive system, with reference to FIGS. 3-8.

### FIG. 3: DC Based Site Map

This drawing illustrates a DC-based power distribution system for a site, showcasing the main components and their interconnections. Applicant's Atlas power sources (170/350 kWh) serve as the primary energy storage units, connected to a high-voltage direct current (HVDC) transmission grid. These power sources provide a stable and reliable energy supply to the entire system, ensuring continuous operation even during peak demand periods.

The AC Conversion Module, equipped with a 120/208 V 3-phase 30 kW output and a 75 kWh battery, is responsible for converting the HVDC power from the transmission grid to AC power suitable for connected loads. This module ensures a stable and efficient power supply to AC equipment, while the battery provides backup power during grid disruptions.

The DC Conversion Module, which includes a Solar Capture Module (50 kWh battery and 15 kW solar), enables the integration of renewable energy sources into the system. The solar panels generate clean energy, which is stored in the battery for later use. This module helps reduce the system's reliance on fossil fuels and promotes sustainable power generation.

The hybrid node demonstrates the system's versatility by combining various power generation and conversion modules. It includes AC Modules (120/208 V 3-phase 30 KW, 2×75 kWh batteries, 480V 3-phase 70 kW), a DC Module, a Combustion Module, and a Fuel Cell Module. This node can cater to a wide range of power requirements, providing both AC and DC power to connected loads. The Combustion Module and Fuel Cell Module offer additional power generation options, enhancing the system's reliability and flexibility.

FIG. 4: DC Based Site Map with HVDC Transmission Interrupted

This drawing depicts a scenario where the HVDC transmission grid is interrupted, simulating a power outage or maintenance situation. Despite the absence of the main transmission grid, the nested node-based modules continue to operate independently. The AC Conversion Module, DC Conversion Module, and hybrid node rely on their local energy storage and generation capabilities to maintain a stable power supply to connected loads.

The addition of a 25 kW genset and a 15 kW fuel cell in the hybrid node further enhances the system's resilience during grid interruptions. These backup power sources can be activated to supplement the energy storage and ensure continuous operation of critical loads.

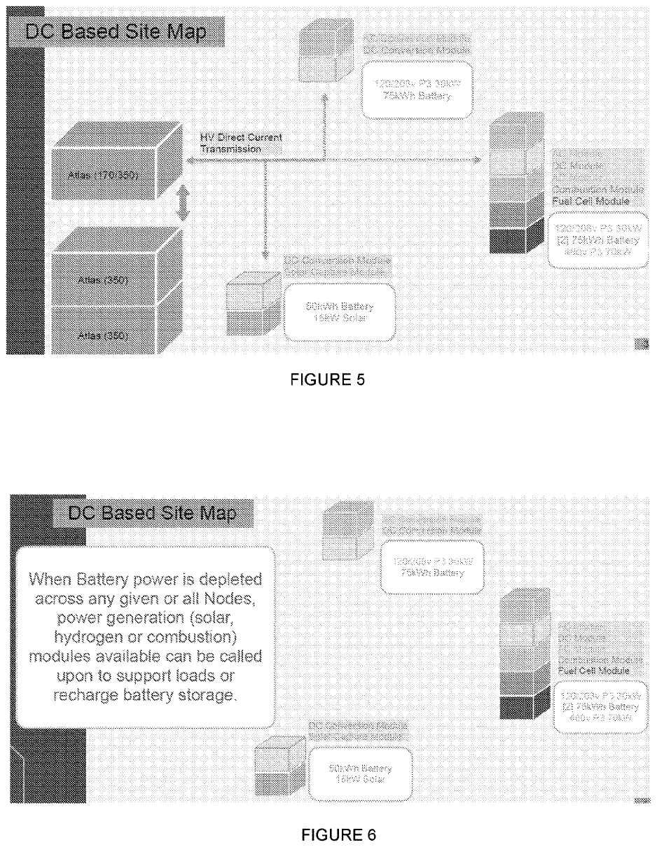

FIG. 5: DC Based Site Map with Battery Power Depleted (1)

This drawing illustrates a situation where battery power is depleted across any given or all nodes, representing a scenario where the system has been operating on stored energy for an extended period. In such cases, the available power generation modules (solar, hydrogen, or combustion) can be called upon to support the loads and recharge the depleted battery storage.

The Solar Capture Module in the DC Conversion Module can harvest solar energy to recharge its battery and support connected loads. Similarly, the Combustion Module and Fuel Cell Module in the hybrid node can generate power to compensate for the depleted batteries and maintain a stable power supply.

FIG. 6: DC Based Site Map with Battery Power Depleted (2)

This drawing is similar to FIG. 5, focusing on the system's response when battery power is depleted across multiple nodes. The power generation modules, such as the solar panels, combustion engine, and fuel cell, play a crucial role in restoring the energy balance within the system.

The Solar Capture Module prioritizes recharging its own battery while simultaneously supporting connected loads. The Combustion Module and Fuel Cell Module in the hybrid node ramp up their power generation to recharge the depleted batteries and ensure a continuous power supply to critical loads.

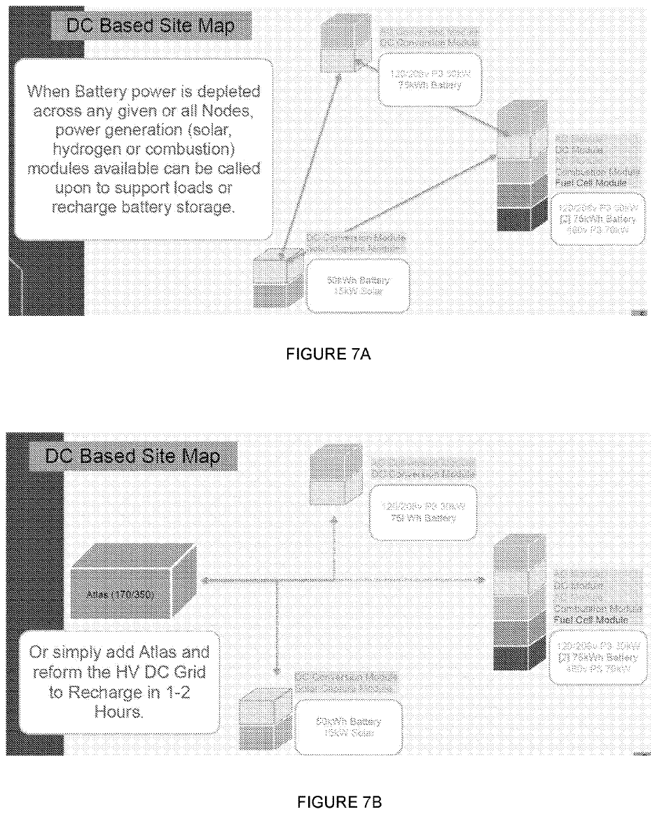

FIGS. 7A, 7B: DC Based Site Map with Atlas Power Source Added

These drawings illustrate the system's ability to quickly recover from a depleted battery scenario by adding an Atlas power source to reform the HVDC transmission grid. The Atlas power source, with its high energy storage capacity, can recharge the entire system within 1-2 hours.

By connecting the Atlas power source to the HVDC transmission grid, the system can efficiently distribute the stored energy to all the connected nodes. The AC Conversion Module, DC Conversion Module, and hybrid node can rapidly recharge their batteries and resume normal operation, minimizing downtime and ensuring a swift recovery.

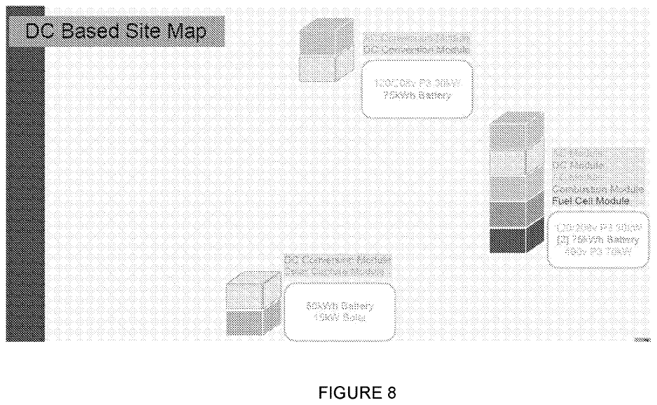

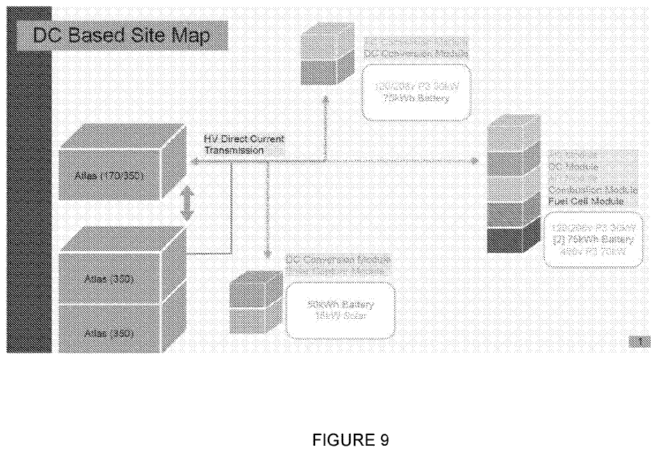

### FIG. 8: DC Based Site Map Operating Independently

This drawing illustrates the system's capability to operate independently without the HVDC transmission grid. In this scenario, each node relies on its local energy generation and storage capabilities to maintain a stable power supply to connected loads.

The AC Conversion Module utilizes its battery storage and AC output to support AC loads, while the DC Conversion Module leverages its solar generation and battery storage to power DC loads. The hybrid node, with its diverse power generation options (AC Modules, DC Module, Combustion Module, and Fuel Cell Module), can cater to a wide range of power requirements and ensure continuous operation.

The independent operation of the nodes highlights the system's resilience and adaptability. Even in the absence of the main transmission grid, the WASP NET system can continue to provide reliable power to critical loads, making it suitable for various applications, including emergency power supply scenarios and remote locations with limited grid access.

FIG. 9: The resiliency of the WASP NET system may be further enhanced by having multiple Atlas units connected to the DC grid at the same time as illustrated in FIG. 9. In existing off-grid applications using combustion generators, customers often must provide secondary generators on-site to allow for failure of the primary generator. Switching over to a secondary generator will necessarily result in interruption of power to the system which is undesirable. Having multiple Atlas units connected to the DC bus enables seamless, uninterrupted power to the WASP NET in the event of a failure in one of the Atlas units.

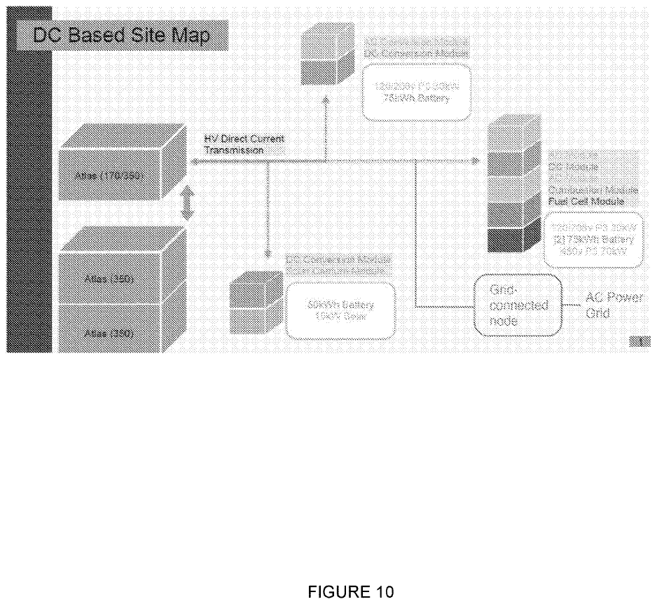

FIG. 10: The WASP NET system may be further enhanced with the inclusion of a grid connected node as shown in FIG. 10. In some applications, grid power is available, however, such grid power may be limited and unable to provide full power for the connected loads. The grid connected node shown in FIG. 10 is able to take AC power from the grid at any available level and convert it to DC power for transmission on the direct current transmission grid.

The grid connected node shown in FIG. 10 may be unidirectional in nature, or it may be bidirectional and capable of supplying power to the AC grid from the WASP NET system. Shot such operation might be desirable for shifting time of use of grid power or avoiding demand surcharges imposed by grid operators.

The modular and scalable design of the WASP NET system, as demonstrated in FIGS. 3-10, allows for easy customization and expansion based on specific site requirements. The ability to integrate various power generation and storage technologies, along with the seamless transition between grid-connected and independent operation modes, makes the WASP NET system a versatile and reliable solution for temporary and semi-permanent power distribution needs.

### CONCLUSION

The WASP NET system represents a significant advancement in deployable power distribution technology, offering a more efficient, resilient, and versatile solution compared to conventional AC systems. By harnessing the benefits of high-voltage DC transmission, modular power electronics, and intelligent power management, the system delivers reliable and flexible power over a wide area from a variety of AC and DC sources.

The invention is not limited to the specific embodiments and examples described herein. The modular, reconfigurable architecture of the WASP NET system can be adapted and scaled to meet the unique power demands of a broad range of sites and applications beyond those explicitly mentioned, including but not limited to industrial facilities, disaster relief operations, off-grid communities, military FOBs, and more. Various modifications to the system components, power levels, voltage configurations, control schemes, and layout can be implemented to optimize performance for a particular use case.

Furthermore, the system's ability to seamlessly integrate renewable energy sources, advanced battery storage, and alternative power generation technologies allows it to be customized for maximum efficiency, sustainability and cost-effectiveness given the available resources and environmental conditions at a site. As new power electronic devices, battery chemistries, charging methods, fuel cells, and other technologies emerge, they can be readily incorporated into the flexible WASP NET framework.

In summary, the WASP NET system establishes a new paradigm for resilient, mobile energy infrastructure that can be rapidly deployed to provide versatile, efficient, and robust power wherever and whenever it is needed. Its novel architecture and capabilities make it a transformative solution with the potential for wide-ranging impacts across industries and environments worldwide.

We claim:

1. A Wide Area Site Power and Nested Energy Transmission (WASP NET) system comprising:
one or more a major power-generation node(s) comprising high-capacity energy sources;
a high-voltage DC (HVDC) transmission grid connected to the major power-generation node(s);
a plurality of secondary nodes connected to the HVDC transmission grid, each secondary node comprising at least one of a power generation module, a power conversion module, and an energy storage module; and
a control system for managing power distribution and sharing among the nodes.

2. The WASP NET system of claim 1, wherein the major power-generation node comprises at least one power source providing 170 kWh or 350 kWh of energy storage.

3. The WASP NET system of claim 1, wherein the secondary nodes include at least one of a minor solar-power generation node, an AC power-providing node, and a hybrid node comprising both power sources and power-providing subnodes.

4. The WASP NET system of claim 1, wherein the major power-conversion node includes at least one of a DCDC converter 5. The WASP NET system of claim 3, wherein the minor solar-power generation node comprises a solar capture module and a battery storage module.

6. The WASP NET system of claim 3, wherein the AC power-providing node comprises an AC conversion module for converting HVDC power to AC power and a battery storage module for local energy storage.

7. The WASP NET system of claim 3, wherein the hybrid node comprises at least one of a combustion module and a fuel cell module for generating power, a DC conversion module for converting generated power to HVDC, and a plurality of AC and DC power-providing subnodes.

8. The WASP NET system of claim 3, wherein the hybrid node comprises at least one hybrid inverter, where a primary DC input, a secondary AC input and at least one secondary DC input configured to receive solar energy can be configured to use DC battery input.

9. The WASP NET system of claim 1, wherein the secondary nodes are configured to operate independently using local power generation and storage capabilities in case of power disruptions on the HVDC transmission grid.

10. The WASP NET system of claim 1, wherein the control system enables power sharing and charging among the secondary nodes when the major power-generation node is offline.

11. The WASP NET system of claim 1, further comprising a centralized battery swapping system at the major power-generation node for optimizing system performance and reducing maintenance requirements.

12. The WASP NET system of claim 1, wherein the HVDC transmission grid reduces cabling requirements, minimizes electromagnetic interference, and increases power transmission capacity compared to traditional AC power distribution systems.

13. The WASP NET system of claim 1, further comprising a de-centralized battery swapping system at the secondary power-generation node or nodes for optimizing system performance and reducing maintenance requirements.

14. The WASP NET system of claim 1, further comprising a de-centralized battery swapping system at the secondary power-generation node or nodes where a hybrid node includes a secondary DC solar input which may be capable of accepting a DC input that is a battery.

15. The WASP NET system of claim 1, further comprising a de-centralized battery swapping system at the secondary power-generation node or nodes where a hybrid node includes a secondary DC solar input which may be capable of accepting a DC input that is a fuel cell.

16. The wasp nest system of claim 1, wherein a grid connected node capable of excepting or delivering power to an AC power grid is provided.

17. A method for operating a Wide Area Site Power and Nested Energy Transmission (WASP NET) system, the method comprising:
generating power at a major power-generation node;
distributing the generated power over a high-voltage DC (HVDC) transmission grid to a plurality of secondary nodes;
converting the HVDC power at each secondary node to meet the requirements of connected loads;
operating the secondary nodes independently using local power generation and storage capabilities in case of power disruptions on the HVDC transmission grid; and
enabling power sharing and charging among the secondary nodes when the major power-generation node is offline.

18. The method of claim 17, further comprising converting HVDC power to AC power at an AC power-providing node using an AC conversion module.

19. The method of claim 17, further comprising converting HVDC power to AC or DC power at a hybrid node using respective AC and DC power-providing subnodes.

20. The method of claim 17, further comprising generating and storing renewable energy at a minor solar-power generation node using a solar capture module and a battery storage module.

21. The method of claim 17, further comprising generating power at a hybrid node using at least one of a combustion module and a fuel cell module and converting the generated power to HVDC using a DC conversion module.

22. The method of claim 17, further comprising centralized battery swapping at the major power-generation node for optimizing system performance and reducing maintenance requirements.

23. The method of claim 17, wherein the HVDC transmission grid reduces cabling requirements, minimizes electromagnetic interference, and increases power transmission capacity compared to traditional AC power distribution systems.

24. The method of claim 17, further comprising managing power distribution and sharing among the nodes using a control system.

25. The method of claim 17, wherein the secondary nodes include at least one of a minor solar-power generation node, an AC power-providing node, and a hybrid node comprising both power sources and power-providing subnodes.

26. The method of claim 17, wherein the major power-generation node comprises at least one power source providing 170 kWh or 350 kWh of energy storage.

27. The method of claim 17, wherein the secondary nodes include at least one of a minor solar-power generation node, an AC power-providing node, and a hybrid node comprising both power sources and power-providing subnodes wherein the solar-power generation node may utilize the DC input from a battery, a swappable battery, a DC fuel cell or other intermittent DC source which is not from solar.
